(19) United States
(12) Patent Application Publication
(10) Pub. No.: US 2006/0149529 A1
(43) Pub. Date: Jul. 6, 2006

(54) Method for encoding messages between two devices for transmission over standard online payment networks

(76) Inventors: Loc Nguyen, San Francisco, CA (US); Janet Pruitt, Mill Valley, CA (US); Stacy Pourfallah, Oakland, CA (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/231,026

(22) Filed: Sep. 20, 2005

Related U.S. Application Data
(60) Provisional application No. 60/641,483, filed on Jan. 4, 2005.
(60) Provisional application No. 60/641,464, filed on Jan. 4, 2005.
(60) Provisional application No. 60/641,597, filed on Jan. 4, 2005.

(51) Int. Cl. G06Q 10/00; G06F 17/27

(52) U.S. Cl. 704/9; 705/2

(57) ABSTRACT

A method of using a dictionary of message codes related to health care information is provided. The message codes in the dictionary have corresponding message values. The method includes receiving at least one message value at a first device. The first device then generates at least one message code related to health care information from the at least one message value using corresponding message values from the dictionary. The method also includes transmitting the at least one message code over a payment processing network.

### CROSS-REFERENCES TO RELATED APPLICATIONS

This application is a non-provisional of and claims priority to the following U.S. provisional patent applications, which are incorporated by reference in their entirety for all purposes.
Application No. 60/641,483, filed Jan. 4, 2005, entitled “Method and System for Determining Healthcare Eligibility”;
Application No. 60/641,597, filed Jan. 4, 2005, entitled “Auto Adjudication for Over-the-Counter Transactions”; and
Application No. 60/641,464, filed Jan. 4, 2005, entitled “Method for Encoding Messages Between Two Devices for Transmission Over Standard Online Payment Networks”.

### BACKGROUND OF THE INVENTION

Data communications networks are widespread in the United States. Many types of messages and transactions are sent through such networks, including electronic mail, news stories, and financial transactions. Some data networks provide mechanisms for transmitting payment information from a merchant to a financial institution and vice versa. These networks are sometimes referred to as payment processing networks.

Payment processing networks are generally highly reliable, secure, and fast. Point of sale (POS) terminals coupled to such payment processing networks are generally widely available at merchants and other locations. However, some payment processing networks limit the amount and type of data communicated through the network in order to achieve system goals such as reliability, security, and speed. For example, in some payment processing networks, only financial data associated with a transaction, typically user identification information and transaction value, is transmitted through the network. By limiting the data sent through the network to financial data, some network operators are able to maximize the number of transactions sent through the network.

In the context of health care services and products, there is currently an increased demand for network operators to provide for the communication of non-financial data. Such non-financial data includes, for example, benefit verification, medical eligibility, physician referrals, and claims processing information. Some health care providers/professionals (e.g. doctors, dentists, hospitals) would prefer to determine, at the time when services are rendered, whether an individual's health insurance coverage is current or the amount of co-pay for which the individual is responsible. However, payment processing networks are generally not currently configured to provide for communication of this non-financial data.

Therefore, it would be desirable to provide a method and system that is capable of communicating information related to health care transactions in an efficient and expedited manner over a payment processing network.

Embodiments of the present invention address these and other problems, individually and collectively.

### SUMMARY OF THE INVENTION

Embodiments of the present invention are directed to the communication of health care information. More particularly, the invention includes a method of transmitting health care information over a payment processing network. Merely by way of example, the invention has been applied to the use of a dictionary of message codes related to health care information to generate message codes using corresponding message values from the dictionary. The method and apparatus can be applied to health care service information as well as health care product information and patient and product eligibility.

One embodiment according to the present invention is directed to a method of using a dictionary of message codes related to health care information, the message codes having corresponding message values. The method comprises receiving at least one message value at a first device. The method also comprises generating at least one message code from the at least one message value using corresponding message values from the dictionary and transmitting the at least one message code over a payment processing network, wherein the at least one message code relates to health care information.

Another embodiment of the present invention is directed to an apparatus using a dictionary of message codes related to health care information, the message codes having corresponding message values. The apparatus comprises a computer readable medium including code for receiving at least one message value at a first device and code for generating at least one message code from the at least one message value using corresponding message values from the dictionary. The computer readable medium also includes code for transmitting the at least one message code over the payment processing network, wherein the at least one message code relates to health care information.

Embodiments of the present invention have a number of advantages. Embodiments of the invention can be used to communicate non-financial data using an existing payments infrastructure and using the computing capabilities in common POS terminals. Embodiments of the invention can also support the sending and receiving of non-financial data over a payment processing network by utilizing a mutually-agreed upon dictionary of message codes related to health care information. These message codes, which have a reduced data size, can be generated from the dictionary using corresponding message values, which have a large data size. As a result, the compressed non-financial data can be communicated in an efficient manner over existing payment processing networks.

Reference to the remaining portions of the specification, including the drawings and claims, will realize other features and advantages of the present invention. Further features and advantages of the present invention, as well as the structure and operation of various embodiments of the present invention, are described in detail below with respect to accompanying drawings, like reference numbers indicate identical or functionally similar elements.

### BRIEF DESCRIPTION OF THE DRAWINGS

FIG. 1 is a simplified schematic diagram illustrating a system for transmitting health care information over a payment processing network according to one exemplary embodiment of the present invention;

FIG. 2 is a table showing a sample list of message codes and their corresponding message values in a dictionary according to one exemplary embodiment of the present invention;

FIG. 3 is a flowchart illustrating an exemplary process for composing and providing a message according to one exemplary embodiment of the present invention;

FIG. 4 is a table showing a sample list of message codes and their corresponding message values in another dictionary according to another exemplary embodiment of the present invention;

FIG. 5 is a flowchart illustrating another exemplary process for composing and providing a message according to another exemplary embodiment of the present invention; and

FIG. 6 is a table showing a sample list of message codes and their corresponding message values in yet another dictionary according to yet another exemplary embodiment of the present invention.

### DETAILED DESCRIPTION

Some health care providers communicate with insurance companies and claims processors regarding non-financial aspects of patient services using dedicated computers coupled to high bandwidth networks, such as the Internet. In some cases, the health care provider uses a desktop computer coupled to the Internet to log on to a website, input patient and access-security information, and determine, for example, patient eligibility for a particular medical procedure. However, many health care providers, such as physicians operating individual offices, have been relatively slow to adopt the use of high bandwidth networks coupled to dedicated computers, such as PCs, owing to the cost and complexity of purchasing, upgrading, and maintaining equipment. Moreover, the cost of training employees to operate such systems has slowed market penetration.

A certain number of health care providers communicate with insurance companies and claims processors regarding non-financial aspects of patient services using standard POS terminals coupled to proprietary networks. For example, some companies (e.g., SpotCheck and ProxyMed) have developed electronic eligibility verification systems using POS terminals. However, such systems generally require the use of specialized POS terminals and/or specialized connections between the health care provider and the proprietary network. In one example, an employee in a physician's office could connect the POS terminal to the proprietary network by calling a dedicated number associated with the proprietary network. The system could be used to determine patient eligibility for a service.

Because these proprietary networks are not integrated with payment processing networks, they do not process payments and generally have reduced system infrastructure, including security measures, compared to payment processing networks. Therefore, continuing the example, either the physician's office would have to provide a dedicated POS terminal connected to the proprietary network or an office employee would have to disconnect the POS terminal from the proprietary network and reconnect the POS terminal to the payment processing network in order to communicate both financial and non-financial data. This lack of integration between payment processing networks and these proprietary networks has slowed market penetration of this approach.

On the other hand, the market penetration of POS terminals coupled to dedicated payment processing networks is high. The widespread use of portable consumer devices (e.g. payment cards) to pay for health care related products and services has resulted in the widespread adoption and installation of POS terminals. Generally, the POS terminal provides a limited set of possible transactions centered around the processing of financial transactions. Many POS terminals provide for entry of user identification information (such as a credit card number) and the amount of the purchase. Additionally, security information, such as a credit card security code or a patient's zip code, may also be entered into the POS terminal.

However, typical POS terminals do not provide the capability to enter other payment related non-financial data, for example, information related to a particular medical procedure. In some embodiments, the non-financial data is not payment related, for example, an eligibility request separate from a payment related transaction. The existing data fields in many payment processing networks are not adapted to accept the entry of health care transaction data, which generally involves data with field sizes larger than the existing payment processing network data fields. Moreover, many payment processing networks are operated under tight bandwidth constraints. The entry of bandwidth intensive information into a POS terminal, such as descriptions of medical procedures, could require more bandwidth than typically available with payment processing networks.

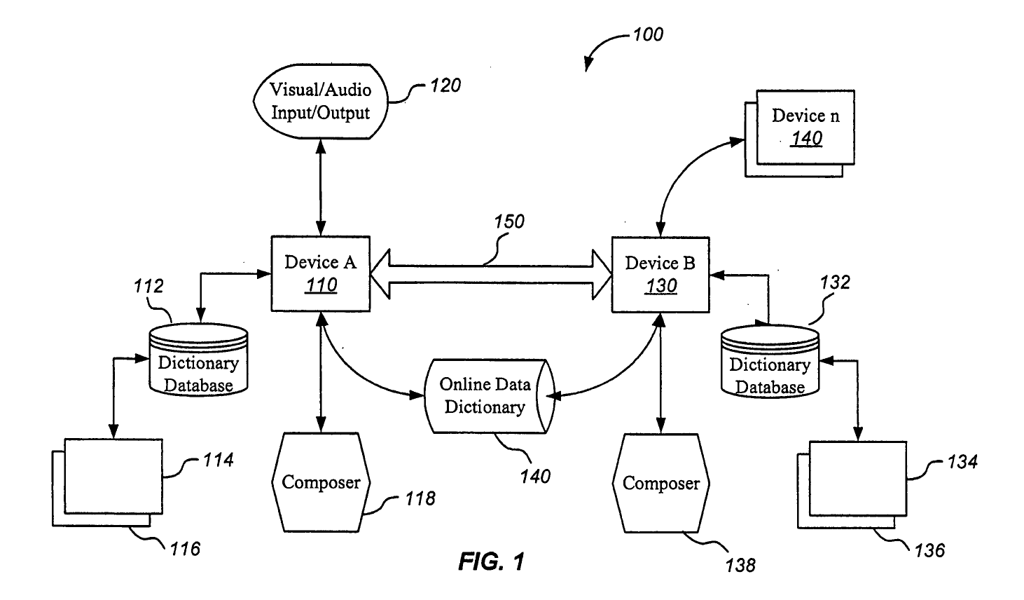

FIG. 1 is a simplified schematic diagram illustrating a system for transmitting health care data over a payment processing network according to one exemplary embodiment of the present invention. As illustrated in FIG. 1, device A 110 is coupled to a dictionary database 112. Device A 110 may be a POS terminal like those that are presently available to interact with ordinary payment cards (e.g., debit or credit cards). In FIG. 1, one device A 110 is described for simplicity of illustration. It is understood that there may be many more devices or terminals in embodiments of the invention.

Device A 110 may interact with a portable consumer device (not shown). Examples of portable consumer devices include credit cards, debit cards, healthcare insurance cards, smartcards, driver's licenses, personal digital assistants, ATM cards, security badges, access badges, stored value cards, pagers, and the like. Interaction between device A 110 and the portable consumer device can be facilitated using any suitable optical, magnetic, electromagnetic, or electronic mechanism. In some embodiments, the portable consumer device is in the form of a card and has a magnetic stripe.

In one embodiment of the present invention, dictionary database 112 includes one or more dictionaries, for example, dictionaries 114 and 116. Each dictionary 114 and 116 includes a database of message codes and their corresponding message values or meanings. Dictionary database 112 may be embedded in device A 110. Also, dictionary database 112 may be separate from device A 110 and accessible through a communication medium. For example, dictionary database 112 may be localized in relation to device A 110 and accessible through a network, such as a local area network (LAN), wide area network (WAN), wireless network, wireline network, the Internet, and the like. Also, parts of dictionaries 114 and 116 may be distributed among different devices. For example, part of dictionary 114 may be located in device A 110 and part in dictionary database 112.

In one exemplary embodiment, each dictionary 114 and 116 may be organized in data structures of message codes/words and their respective meanings. Additionally, multiple dictionaries may be accessible to device A 110 and different versions of dictionaries may be used by device A 110. As will be further described below, one or more of the dictionaries 114 and 116 in the dictionary database 112 may be selected to allow a message to be composed or generated from a number of message codes.

Composer 118 may be software, embedded software, dedicated hardware, or any combination thereof, that analyzes message values and generates message codes by retrieving the appropriate message codes related to the message values from dictionary 114. Alternatively, composer 118 may be software, embedded software, dedicated hardware, or any combination thereof, that analyzes message codes and generates message values by retrieving the appropriate message values related to the message codes from dictionary 114. For illustrative purposes herein, only one dictionary 114 is used to generate the message. Based on the disclosure and teachings provided herein, it will be clear to a person of ordinary skill in the art that more than one dictionary may be used to generate message values from the message codes and message codes from the message values. Composer 118 may be embedded in device A 110 or be accessible to device A 110. It should be noted that composer 118 may further use information from other sources or databases (not shown) to help compose or generate message values from message codes and message codes from message values.

As illustrated in FIG. 1, the composers may access dictionary databases or online data dictionary 140 during the process of generating the message codes. The online data dictionary 140 is used by both device A and device B in one embodiment of the present invention. Additionally, online data dictionary 140 may include additional sub-dictionaries (not shown) accessible to composers 118 and 138. Updating of online data dictionary 140 may be accomplished by means well known to one of skill in the art.

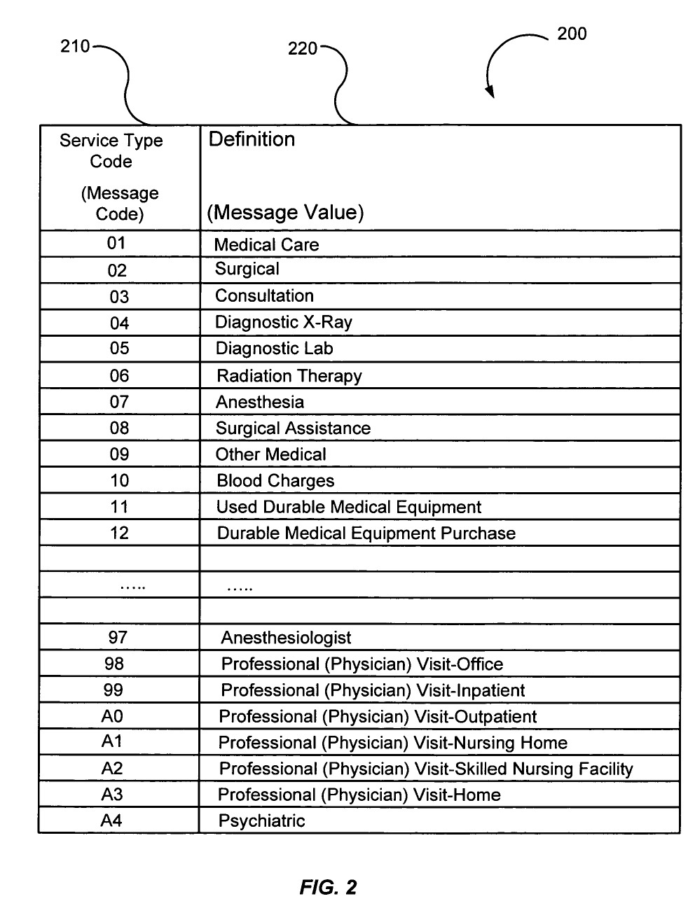

FIG. 2 is a table 200 showing a sample list of message codes and their corresponding message values in one dictionary 114 according to one exemplary embodiment of the present invention. As shown in FIG. 2, table 200 includes a code column 210 that includes message codes and a message value column 220 that includes corresponding message values for the message codes. Although this figure is referred to with respect to dictionary 114, the methods and structures of the present invention are applicable to other dictionaries including dictionary database 132 as well as online data dictionary 140. Additional description of dictionary databases is provided in commonly owned U.S. patent application Ser. No. 10/244,044, filed Sep. 13, 2002, entitled “Compact Protocol and Solution for Substantially Offline Messaging Between Portable Consumer Device & Base Device,” which is incorporated by reference for all purposes.

Message codes may be stored in a binary form, hexadecimal form, or any other standardized format that is interpretable by device A 110 and/or composer 118. Based on the disclosure and teachings provided herein, a person of ordinary skill in the art will know how to use different formats to store the message codes depending on the system design and requirements. The message codes may be in any suitable form. For example, they may be in the form of a two or three digit code in some embodiments. For example, “02” may be a code for “Surgical”. As illustrated in FIG. 2, although the illustrated message code field size is two digits long, more than 100 message codes are available using a message code field size of only two digits. Following code “99”, “Professional (Physician) Visit—Inpatient,” code “A0” is used to represent “Professional (Physician) Visit—Outpatient.” Therefore, by use of standardized formats including alphanumeric codes, varieties of codes can be stored in dictionaries according to embodiments of the present invention.

In one embodiment of the present invention, dictionary database 112 includes healthcare-related Service Type Codes, such as those that may be defined by the Health Insurance Portability and Accountability Act of 1996 (HIPAA). As illustrated in FIG. 2, the Service Type Code ID is a code identifying the type of service being rendered by the health care provider. In a specific embodiment, the format for the Service Type Code ID data element is an alphanumeric string with a length of two characters. In some embodiments, this Service Type Code ID is referred to as a message code. Alternative embodiments provide Service Type Code IDs with other formats that are suitable for identifying particular services and products. In this specific embodiment, another data element provided by the dictionary database 112 is the definition or message value associated with a particular message code or Service Type Code ID. The definition, which provides an explanation of the associated message code is an alphanumeric string with a length of 30 characters. Of course, the length and format of the data elements in dictionary database 112 will depend on the particular application. One of ordinary skill in the art would recognize many variations, modifications, and alternatives.

As illustrated in FIG. 2, the dictionary also includes a message value column 220 that includes corresponding message values for the message codes. The message values may be in any suitable form. For example, a message value may be in the form of a text message (e.g., “surgical”) or an encoded text message of some sort. The message values preferably relate to a health care message.

Dictionaries 114 and 116 in the dictionary database 112 may be up dated at any time. For example, message codes and/or message values may be changed and new message codes and/or message values may be added. Updates may be provided periodically to dictionary database 112 in a number of ways, for example, by a de-localized service management host or server or other computing device used for the management of the dictionary database 112. Furthermore, updates may be performed on an automated, pre-scheduled basis or in an ad hoc manner.

Referring to FIG. 1, a message generated by composer 118 may be transmitted from device A 110 to device B 130 over payment processing network 150. Payment processing network 150 is generally a component of a transaction processing system, which may be primarily used for processing financial transactions.

The payment processing network 150 may be specifically adapted to process financial transactions. An example is Visanet. It may facilitate communication between one or more acquirer institutions (e.g., acquirer banks), issuer institutions (e.g., issuer banks), buyers and sellers. Payment processing networks 150 typically transmit authorization request messages and response messages more quickly than other types of networks, since payment transactions need to be processed faster than other types of transactions (e.g., an e-mail transaction).

In some embodiments, device A 110 is associated with a health care provider. As discussed above, because some payment processing networks have limitations on the bandwidth available for messages or available data formats, conversion of the message values into message codes by the composer 118 prepare the message for communication over the payment processing network in an efficient manner. When the message transmitted from device A 110 to device B 130 is received at device B, composer 138 and dictionary database 132 are used to convert the message codes back to message values. In some embodiments, because the message value data elements occupy more memory space than the message code data elements, the size of the message after decoding at device B 130 is increased. In some embodiments, dictionary 134, for example, is identical to dictionary 114. Thus, a message composed using composer 118 and dictionary 114 can be decomposed using composer 138 and 134. Hence, message values input using visual/audio input/output device 120 can be transmitted as message codes over payment processing network 150 and converted back to the original message values at device B 130.

In some embodiments of the present invention, patient information and healthcare information are entered into and received by device A 110 and an authorization request message may then be formatted at device A. The authorization request message may be formatted as an International Standards Organization (ISO) type, non-financial, information message. In some cases, the authorization request message may be an ISO 8583 type message, a standard (VisaNet) authorization request message.

In a specific embodiment of the present invention, receiving a message at device B 130 comprises determining the authenticity and version of the dictionary and coding format used by device A 110. This information is used by composer 138 during the process of converting the transmitted message codes to generate the original message values. Moreover, in some embodiments, the message values generated by composer 138 are output in either visual, audio, machine-readable format, or the like by suitable devices (not shown). Additionally, the original message values, or other message values input or generated by device B 130 may be converted to message codes by composer 138 and transmitted back to device A 110 or sent to device n 140, among other devices.

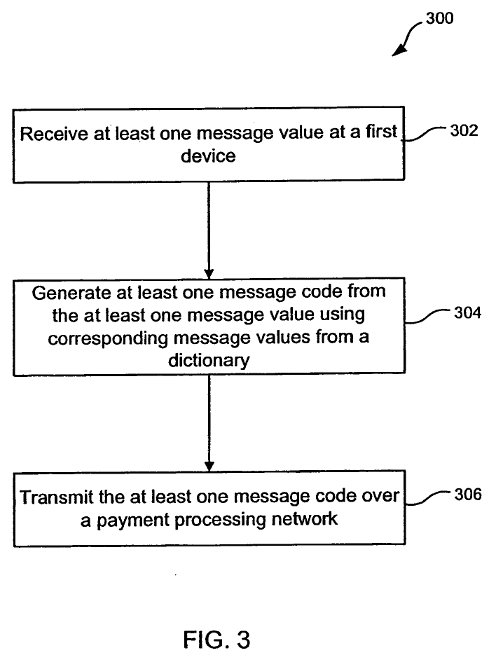

FIG. 3 is a flowchart illustrating an exemplary process for composing and providing a message according to one exemplary embodiment of the present invention. As illustrated in FIG. 3, a method 300 of using a dictionary of message codes related to health care information is provided. The message codes having corresponding message values in the dictionary. In step 302, the method includes receiving at least one message value at a first device. At least one message code is generated from the at least one message value using corresponding message values from the dictionary in step 304. In step 306, the at least one message code is transmitted over a payment processing network. In embodiments of the present invention, the at least one message code relates to health care information.

Some embodiments of the present invention provide a method to transmit health care information related to health care eligibility. Message values are received at a first device, typically at POS terminal, as a result of data entry performed by an employee of a health care provider. In a specific embodiment, the message value that is input/output is related to health care eligibility information associated with a patient. In another specific embodiment, the message value that is input/output is related to health care eligibility information associated with a health care product.

One example using an exemplary embodiment of the present invention will now be described. Message values representing services provided in a physician's office are received at device A 110 as a result of office personnel using visual/audio input/output device 120 to enter patient information. In some embodiments, the message values are received at a POS terminal that includes a number of hierarchical menu options selectable by the operator. For example, an employee in the physician's office could select a menu for transmitting health care information. A sub-menu could provide for selection of a range of service messages, such as clerical entries or medical procedures. Further sub-menus would provide additional detail, ultimately providing for the selection of a particular HIPAA-defined Service Type Code ID. In other embodiments, the message values are received at a first device, such as a computer in the physician's office coupled to the payment processing network. Similar menu driven or command driven software operating on the computer are used in one embodiment to select or enter particular Service Type Code IDs. Thus, codes may be entered manually or automatically.

After selection of the Service Type Code ID in this exemplary embodiment, the composer 118 generates at least one message code from the received/entered message value. In some embodiments, multiple message values are received and multiple message codes are generated. For example, in a specific embodiment, a patient receives several services during an office visit. Accordingly, the office personnel enters message values for each of the services rendered and corresponding message codes are generated for each of the message values using the dictionaries. The generated message codes are transmitted over the payment processing network to a second device. In some embodiments, the second device is associated with an acquirer processor system or an issuer processor system. In turn, in these exemplary embodiments, the systems with which the second device are associated, are coupled to the health care insurance carrier eligibility database.

In some embodiments of the present invention, the code to be transmitted through payment processing network 150 is entered directly into the POS terminal. For example, office personnel may enter message codes into visual/audio input/output device 120. Merely by way of example, a printed index of message codes and corresponding message values may be used to ascertain a message code appropriate to a particular medical service or product. Other means of retrieving or determining message codes are utilized in alternative embodiments. The message code is entered into device 120 and communicated to device A 110, which is adapted to recognize the message code and transmit the message code to device B 130 without recourse to the dictionary database 112.

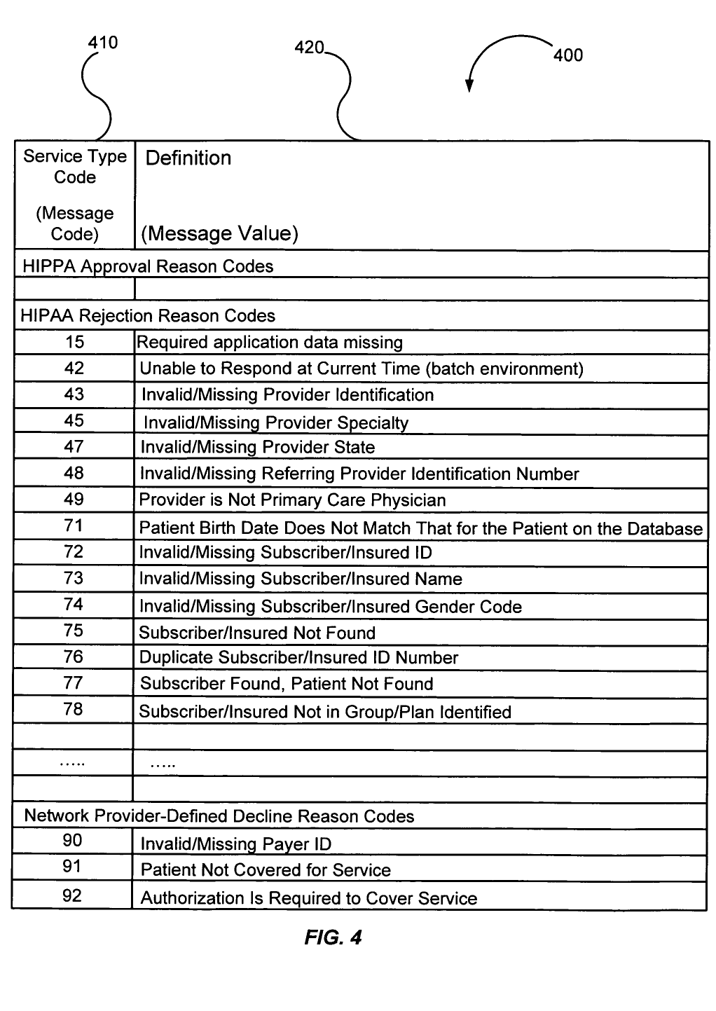

FIG. 4 is a table showing a sample list of message codes and their corresponding message values in another dictionary database according to another exemplary embodiment of the present invention. As shown in FIG. 4, table 400 includes a code column 410 that includes message codes and a message value column 420 that includes corresponding message values for the message codes. Some embodiments of the present invention provide dictionaries with codes for both health care services and health care products, including stock keeping unit (SKU) numbers.

Message codes in table 400 may be stored in a binary form, hexadecimal form, or any other standardized format that is interpretable by the composers. Based on the disclosure and teachings provided herein, a person of ordinary skill in the art will know how to use different formats to store the message codes depending on the system design and requirements.

In one embodiment of the present invention, the dictionary database illustrated in FIG. 4 includes healthcare-related Rejection Codes, such as those that may be defined by HIPAA or a service provider. The table illustrated in FIG. 4 is not an exhaustive list of codes, but merely provides an exemplary list of codes. Although the table in FIG. 4 only provides for rejection codes, one of skill in the art will appreciate that the table may also include any number of suitable approval codes. Any suitable approval codes, defined either by HIPAA or the network provider are covered within the scope of the present invention. In some cases, the number of approval codes is less than the number of rejection codes since approval is typically unaccompanied by significant explanation.

As illustrated in FIG. 4, the Rejection Code ID is a code that may be assigned by HIPAA or a service provider identifying the response action taken by, for example, the insurance carrier. In a specific embodiment, the format for the Rejection Code ID data element is an alphanumeric string with a length of two characters. In some embodiments, this Rejection Code ID is referred to as a message code. Alternative embodiments provide Rejection Code IDs with other formats that are suitable for identifying particular services and products. In the specific embodiment illustrated in FIG. 4, another data element provided by the dictionary database is the definition or message value associated with a particular message code or Rejection Code ID. The definition, which provides an explanation of the associated message code is an alphanumeric string with a length of 30 characters. Of course, the length and format of the data elements in dictionary database will depend on the particular application. One of ordinary skill in the art would recognize many variations, modifications, and alternatives.

Dictionaries in the dictionary databases 112, 132, and 140 may be updated at any time. For example, message codes and/or message values may be changed and new message codes and/or message values may be added. Updates may be provided periodically to the dictionary databases in a number of ways, for example, by a de-localized service management host or server or other computing device used for the management of the dictionary databases. Furthermore, updates may be performed on an automated, pre-scheduled basis or in an ad hoc manner.

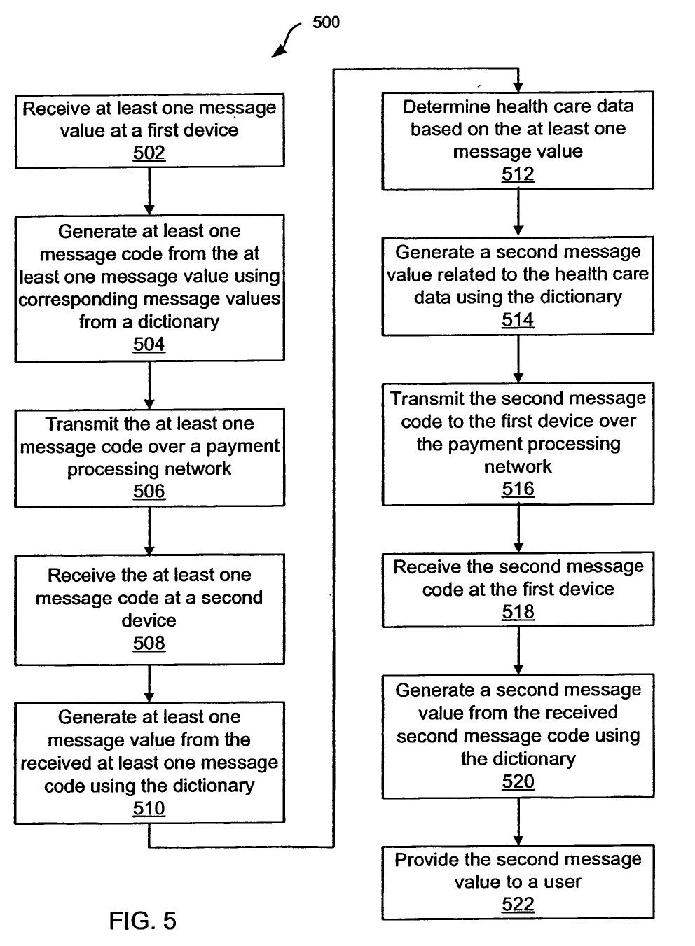

FIG. 5 is a flowchart illustrating another exemplary process for composing and providing a message according to a specific exemplary embodiment of the present invention. As illustrated in FIG. 5, a method 500 of using a dictionary of message codes related to health care information is provided. The message codes have corresponding message values in the dictionary. In step 502, the method includes receiving at least one message value at a first device. At least one message code is generated from the at least one message value using corresponding message values from the dictionary in step 504. In step 506, the at least one message code is transmitted over a payment processing network. In embodiments of the present invention, the at least one message code relates to health care information.

In step 508, the at least one message code is received at a second device. The received message code (or codes in some embodiments), is used to generate at least one message value using corresponding message codes from the dictionary in step 510. In step 512, health care data is determined based on the at least one message value. In a particular embodiment, health care eligibility for a health care service is determined based, at least in part, on the message value or values received at the second device. As discussed previously, the dictionary associated with the second device is identical to the dictionary associated with the first device in some embodiments. In alternative embodiments, the dictionaries are not identical, but share common message codes. In some embodiments, of the present invention, the method is terminated at step 512, but this is not required by the present invention.

In an alternative embodiment, the method initiated in FIG. 5 continues to step 514, in which a second message code related to the health care data is generated using corresponding message values from the dictionary. The second message code is transmitted to the first device over the payment processing network in step 516. In step 518, the second message code is received at the first device and a second message value is generated from the received second message code using corresponding message codes from the dictionary in step 520. The second message value is provided to a user in step 522. In some embodiments, the user is an employee in a physician's office, but this is not required by the present invention. In alternative embodiments, the user is a patient or person responsible for the patient's health care or health care payments.

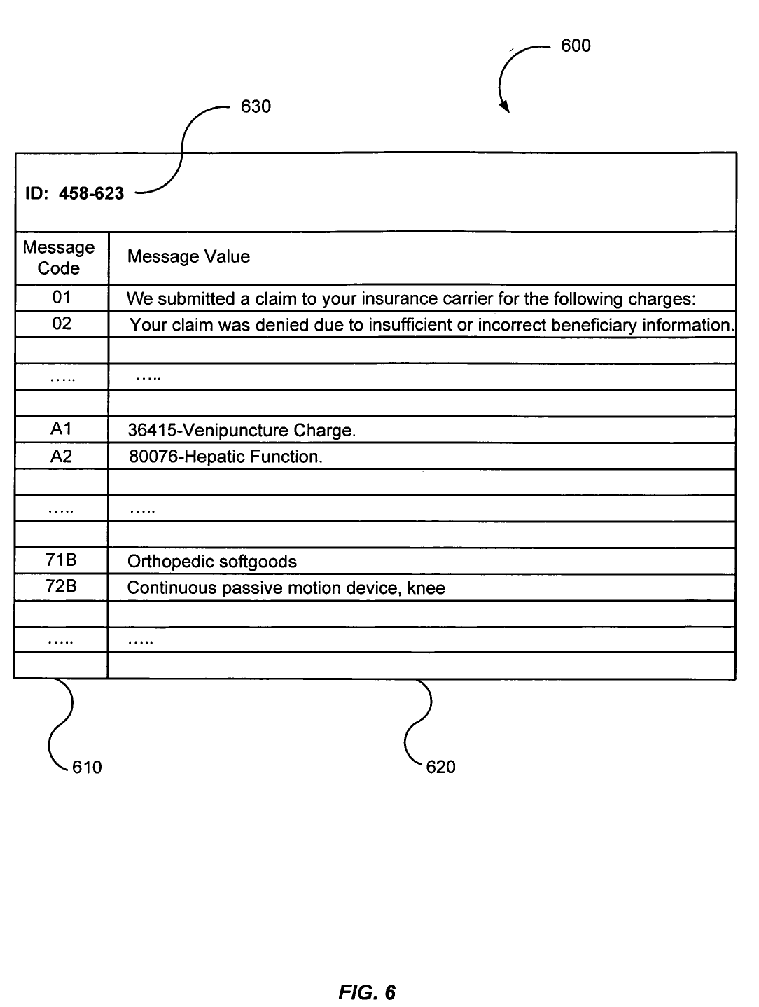

FIG. 6 is a table showing a sample list of message codes and their corresponding message values in yet another dictionary according to yet another exemplary embodiment of the present invention. As shown in FIG. 6, the dictionary includes a dictionary ID number 630, which may specify the identity of the dictionary as well as the version, update date, and the like. As illustrated in FIG. 6, the dictionary ID number for the illustrated table is: 458-623. Additionally, table 600 includes a code column 610 that includes message codes and a value column 620 that includes corresponding message values for the message codes. Message codes in table 600 may be stored in a binary form, hexadecimal form, or any other standardized format that is interpretable by a device and/or an associated composer. Based on the disclosure and teachings provided herein, a person of ordinary skill in the art will know how to use different formats to store the message codes depending on the system design and requirements.

As illustrated by the table in FIG. 6, the message code data field is not limited to an alphanumeric string with a field length of two digits. In FIG. 6, the message code data field is three digits long. One of ordinary skill in the art would recognize many variations, modifications, and alternatives. Moreover, the message codes and message values in FIG. 6 are not limited to healthcare approved codes and definitions. In some embodiments, the operator of the payment processing network selects codes and values that are appropriate to the particular operator's applications. The values associated with codes may be words or phrases related to a medical product or service, such as Orthopedic softgoods; coded phrases, such as 36415-Venipuncture Charge; and complete sentences, such as “Your claim was denied due to insufficient or incorrect beneficiary information.”

Thus, embodiments of the present invention provide for “mixed” dictionaries in which message codes related to products, services, authorizations, rejections, explanations, and the like are included in a single dictionary. These mixed dictionaries may have both healthcare-defined codes and values along with operator-defined codes and values. Alternative embodiments, provide additional dictionaries tailored to specific applications. For example, algorithms are provided in one embodiment that perform a search of first dictionary to locate a desired message code. If the message code is not located, additional dictionaries are searched to locate the desired message code. Transmission of the dictionary ID number, version, and the like of the dictionary utilized in generating the message code accompanies transmission of the message code in one embodiment of the present invention.

Referring to FIG. 6, an example is provided illustrating one exemplary process for composing and providing a message according to one exemplary embodiment of the present invention. For example, in one situation, a health insurer desires to communicate the message: “We submitted a claim to your insurance carrier for the following charges: 36415-Venipuncture Charge. 80076-Hepatic Function. Your claim was denied due to insufficient or incorrect beneficiary information.” The health insurer may communicate these message values by transmitting the message codes: 01 A1 A2 02. Thus, the bandwidth used to communicate the desired message is greatly reduced. Therefore, embodiments of the present invention provide an efficient method for transmitting data messages whose lengths exceed the size of existing payment fields of certain payment processing networks.

In some embodiments of the present invention, the health insurer may communicate both message codes and message values over the payment processing network. For example, some message values are sufficiently brief to be communicated over a payment processing network without conversion into message codes. For these short message values, the amount of storage associated with the dictionary databases is reduced, as message codes associated with these message values may be removed from the dictionary. Thus, a combined message, including both message codes and message values is transmitted through the payment processing network in one specific embodiment according to the present invention.

Referring once again to FIG. 1, an operator of device B 130, for example, a health insurer, may compose a message by generating at least one message code using composer 138 and dictionary 132. The message codes are sent over payment processing network 150 and received at device A 110. In a particular example in which device B is responding to a request from device A, the message values may be provided by a computer coupled to the appropriate dictionary, although this is not required by the present invention. In some embodiments, the health insurer or other entity may analyze received request codes and respond based on the analysis of the received codes. In some cases, the response may be by way of transmitting message codes directly over the payment processing network 150, effectively integrating the functionality of the dictionary 132 and composer 138 into device B 130. The step of receiving the message codes may include determining the authenticity and version of the dictionary and coding format. The message codes are decoded using composer 118 to generate message values that are displayed in visual or audible output on input/output device 120, or in machine-readable format for further composition.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed. Moreover, any one or more features of any embodiment of the invention may be combined with any one or more other features of any other embodiment of the invention, without departing from the scope of the invention.

Also, it should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

All references, patent applications, and patents mentioned above are herein incorporated by reference in their entirety for all purposes. None of them are admitted to be prior art to the presently claimed inventions.

What is claimed is:

1. A method of using a dictionary of message codes related to health care information, the message codes having corresponding message values, the method comprising:
receiving at least one message value at a first device;
generating at least one message code related to health care information from the at least one message value using corresponding message values from the dictionary; and
transmitting the at least one message code over a payment processing network.

2. The method of claim 1 wherein the health care information is related to health care eligibility.

3. The method of claim 1 wherein the at least one message value is related to health care eligibility information associated with a patient.

4. The method of claim 1 wherein the first device is a POS terminal associated with a health care provider.

5. The method of claim 1, further comprising:
determining a version for the dictionary, wherein the step of generating the at least one message code is performed with the determined version for the dictionary.

6. The method of claim 1 wherein the dictionary is locally accessible to the first device.

7. The method of claim 6 wherein the dictionary resides within the first device.

8. The method of claim 1 wherein the at least one message value comprises a semantic value.

9. The method of claim 1 further comprising:
receiving the at least one message code at a second device;
generating the at least one message value from the received at least one message code using corresponding message codes from the dictionary; and
determining health care data based on the at least one message value.

10. The method of claim 9 further comprising:
generating a second message code related to the health care data using corresponding message values from the dictionary;
transmitting the second message code to the first device over the payment processing network;
receiving the second message code at the first device;
generating a second message value from the received second message code using corresponding message codes from the dictionary; and
providing the second message value to a user.

11. The method of claim 10 wherein the health care data comprises patient eligibility for a health care service.

12. The method of claim 10 wherein the health care data comprises patient eligibility for a health care product.

13. The method of claim 10 wherein the health care data comprises health care product eligibility under guidelines associated with a health care flexible spending account or other healthcare reimbursement arrangements.

14. The method of claim 9 wherein the second device is associated with a transaction processor.

15. An apparatus using a dictionary of message codes related to health care information, the message codes having corresponding message values, the apparatus comprising a computer readable medium including:
code for receiving at least one message value at a first device;
code for generating at least one message code from the at least one message value using corresponding message values from the dictionary; and
code for transmitting the at least one message code over the payment processing network, wherein the at least one message code relates to health care information.

16. The apparatus of claim 15 wherein the health care information is related to health care eligibility.

17. The apparatus of claim 15 wherein the first device is a POS associated with a health care provider.

18. The apparatus of claim 15, further comprising:
determining a version for the dictionary, wherein the step of generating the at least one message code is performed with the determined version for the dictionary.

19. The apparatus of claim 15 wherein the dictionary is locally accessible to the first device.

20. The apparatus of claim 19 wherein the dictionary resides within the first device.
